(19) United States
(12) Patent Application Publication
(10) Pub. No.: US 2018/0126777 A1
(43) Pub. Date: May 10, 2018

(54) Vehicle Wheel Rim Shielding Device

(71) Applicant: Gerry Tyson, Winston-Salem, NC (US)

(72) Inventor: Gerry Tyson, Winston-Salem, NC (US)

(21) Appl. No.: 15/348,349

(22) Filed: Nov. 10, 2016

(51) Int. Cl. B60B 7/06

(52) U.S. Cl. CPC B60B 7/06; B60B 2900/211; B60B 2360/50; B60B 7/063

(57) ABSTRACT

A vehicle wheel rim shielding device includes a panel that is circularly shaped and rigid. A gasket is coupled to a circumference of the panel. A handle is coupled to the panel and is positioned on an exterior of the panel. A coupler is coupled to the panel and extends from an interior of the panel. The handle is positioned on the panel such that the handle is configured to be grasped by a hand of the user to place the panel in abutment to the rim for treatment of the tire. The coupler is configured to couple the panel to the rim of the vehicle wheel. The gasket is configured to reversibly seal the panel to the rim of the vehicle wheel. Materials employed by a user in the treatment of a tire attached to the rim do not come into contact with the rim.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to shielding devices and more particularly pertains to a new shielding device for shielding a vehicle wheel rim during tire treatment.

### BRIEF SUMMARY OF THE INVENTION

An embodiment of the disclosure meets the needs presented above by generally comprising a panel that is circularly shaped and rigid. A gasket is coupled to a circumference of the panel. A handle is coupled to the panel and is positioned on an exterior of the panel. A coupler is coupled to the panel and extends from an interior of the panel. The handle is positioned on the panel such that the handle is configured to be grasped by a hand of the user to place the panel in abutment to the rim for treatment of the tire. The coupler is configured to couple the panel to the rim of the vehicle wheel. The gasket is configured to reversibly seal the panel to the rim of the vehicle wheel. Materials employed by a user in the treatment of a tire attached to the rim do not come into contact with the rim.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a vehicle wheel rim shielding device according to an embodiment of the disclosure.

FIG. 2 is a bottom view of an embodiment of the disclosure.

FIG. 3 is a side view of an embodiment of the disclosure.

FIG. 4 is an isometric perspective view of an embodiment of the disclosure.

FIG. 5 is an in-use view of an embodiment of the disclosure.

FIG. 6 is a cross-sectional view of an embodiment of the disclosure.

### DETAILED DESCRIPTION OF THE INVENTION

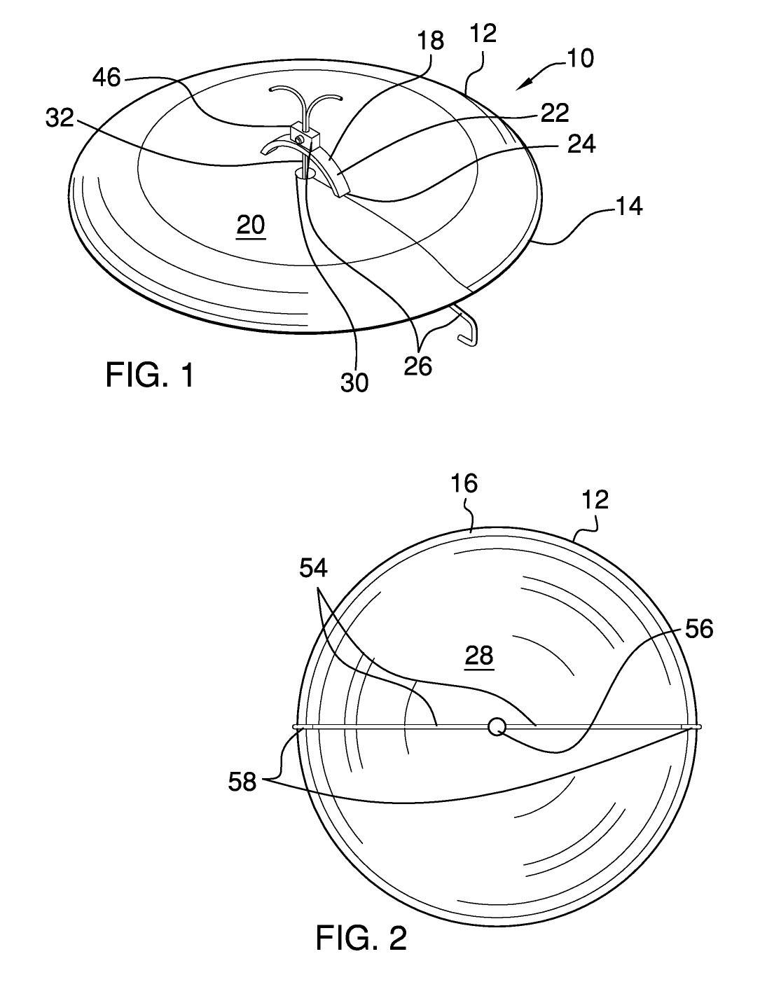

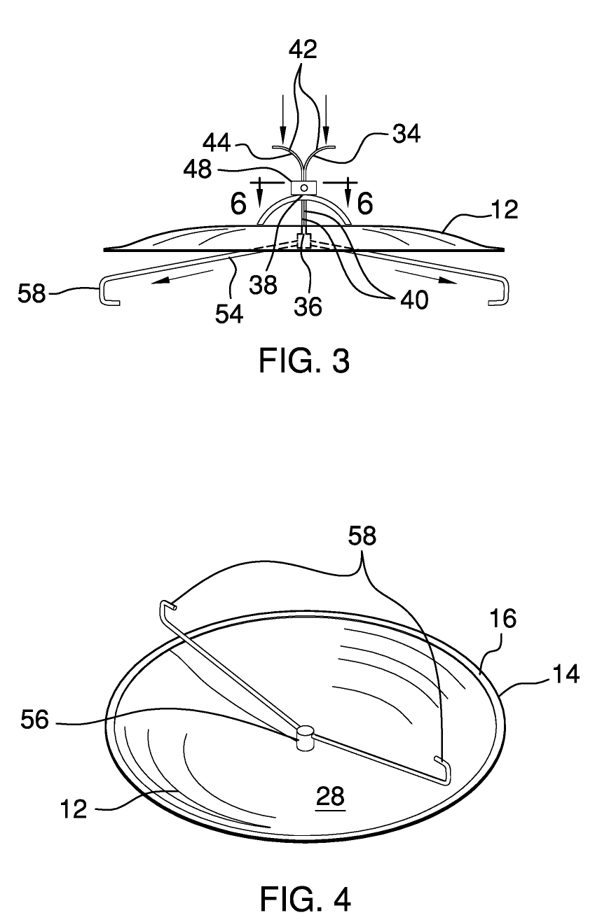

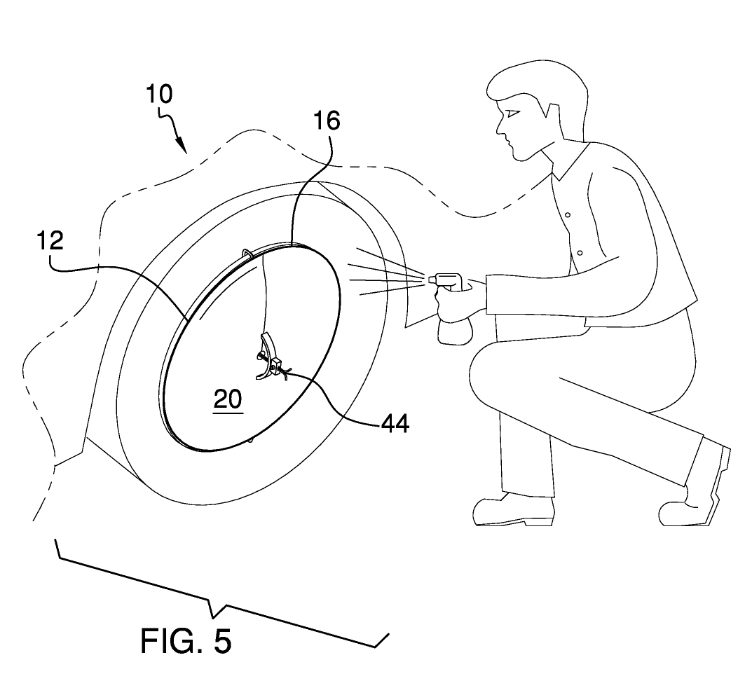

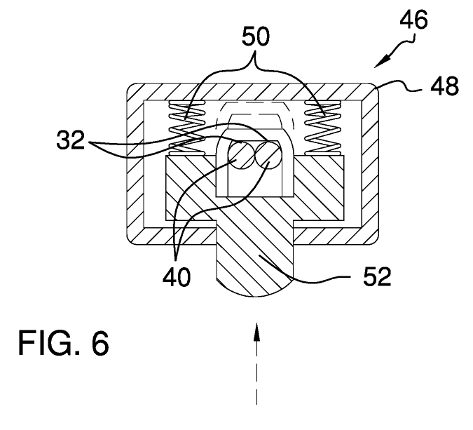

With reference now to the drawings, and in particular to FIGS. 1 through 6 thereof, a new shielding device embodying the principles and concepts of an embodiment of the disclosure and generally designated by the reference numeral 10 will be described.

As best illustrated in FIGS. 1 through 6, the vehicle wheel rim shielding device 10 generally comprises a panel 12 that is circularly shaped and rigid. The panel 12 has a circumference 14 that is substantially equivalent to a perimeter of a rim of a vehicle wheel. In one embodiment, the panel 12 is arcuate such that the panel 12 is domed.

A gasket 16 is coupled to the circumference 14 of the panel 12. The gasket 16 is positioned on the panel 12 such that the gasket 16 is configured to reversibly seal the panel 12 to the rim of the vehicle wheel. Materials employed by a user in the treatment of a tire attached to the rim do not come into contact with the rim. In one embodiment, the gasket 16 comprises rubber.

A handle 18 is coupled to the panel 12 and is positioned on an exterior 20 of the panel 12. The handle 18 is positioned on the panel 12 such that the handle 18 is configured to be grasped by a hand of the user to place the panel 12 in abutment to the rim for treatment of the tire. The handle 18 also is positioned to remove the panel 12 from the rim upon completion of treatment of the tire. In one embodiment, the handle 18 is substantially centrally positioned on the panel 12. In another embodiment, the handle 18 comprises a bar 22 that has opposing ends 24. The bar 22 is arcuate and the opposing ends 24 are coupled to the panel 12. The bar 22 is positioned on the panel 12 such that the handle 18 is configured to insert fingers of the hand of the user between the panel 12 and the bar 22.

A coupler 26 is coupled to the panel 12 and extends from an interior 28 of the panel 12. The coupler 26 is configured to couple to the rim of the vehicle wheel to couple the panel 12 to the rim. The coupler 26 is positioned on the panel 12 such that the coupler 26 is configured to couple the panel 12 to the rim of the vehicle wheel, allowing the user to use both hands in the treatment of the tire.

In one embodiment, the coupler 26 comprises a hole 30 that is centrally positioned through the panel 12. A first rod 32 is slidably positionable through the hole 30. A first end 34 of the first rod 32 is positioned vincinal to the exterior 20 of the panel 12 and a second end 36 of the first rod 32 is positioned vincinal to the interior 28 of the panel 12. In another embodiment, the first rod 32 is slidably positionable through a penetration 38 that is positioned through the handle 18.

In one embodiment, the first rod 32 comprises a pair of shafts 40. A pair of extensions 42 is coupled singly to and extends from the shafts 40 distal from the panel 12. In another embodiment, the extensions 42 are arcuate. The extensions 42 are opposingly positioned and define a grip 44.

A fastener 46 is positioned on the first rod 32 between the first end 34 of the first rod 32 and the exterior 20 of the panel 12. The fastener 46 is reversibly couplable to the first rod 32. The fastener 46 is positioned on the first rod 32 such that the fastener 46 is positioned to selectively couple to the first rod 32 to selectively prevent longitudinal movement of the first rod 32 into the hole 30.

In one embodiment, the fastener 46 is positioned on the first rod 32 between the handle 18 and the first end 34 of the first rod 32. In another embodiment, the fastener 46 comprises a spring clamp 48. The spring clamp 48 comprises a pair of coils 50 and a release button 52. The release button 52 is operationally coupled to the coils 50. The release button 52 is positioned in the spring clamp 48 such that the release button 52 is configured for reversible depression, such that the coils 50 are reversibly compressed. The spring clamp 48 is decoupled from the first rod 32 such that the first rod 32 is slidably positionable with the hole 30.

Each of a pair of second rods 54 is coupled to and extends angularly from the second end 36 of the first rod 32. The second rods 54 are opposingly positioned. In one embodiment, a cylinder 56 is coupled to and extends from the second end 36 of the first rod 32. In this embodiment, the second rods 54 are coupled to the cylinder 56.

A pair of hooks 58 is coupled singly to the second rods 54 distal from the first rod 32. In one embodiment, the hooks 58 are C-shaped. The fastener 46 is positioned on the first rod 32 such that the fastener 46 is positioned to selectively couple to the first rod 32 to selectively prevent longitudinal movement of the first rod 32 into the hole 30. The first rod 32 is positioned through the panel 12 such that the first end 34 of the first rod 32 is configured for the user to motivate the first rod 32 through the hole 30. The first end 34 is motivated toward the exterior 20 of the panel 12 and the second end 36 of the first rod 32 is motivated away from the interior 28 of the panel 12. In this configuration, the hooks 58 are configured to couple to the rim of the vehicle. The first rod 32 also is configured for the user to motivate the first rod 32 through the hole 30 such that the first end 34 is motivated away from the exterior 20 of the panel 12 and the second end 36 of the first rod 32 is motivated toward the interior 28 of the panel 12 so that the hooks 58 are coupled to the rim of the vehicle.

In use, the handle 18 is configured to be grasped by the hand of the user to place the panel 12 in abutment to the rim for treatment of the tire. The handle 18 also is configured to remove the panel 12 from the rim upon completion of treatment of the tire. The release button 52 is configured for reversible depression such that the coils 50 are reversibly compressed. The spring clamp 48 is decoupled from the first rod 32 such that the first rod 32 is slidably positionable with the hole 30. The first rod 32 is configured for the user to motivate the first rod 32 through the hole 30 such that the first end 34 is motivated toward the exterior 20 of the panel 12. The hooks 58 are configured to couple to the rim of the vehicle. The first rod 32 also is configured for the user to motivate the first rod 32 through the hole 30 such that the first end 34 is motivated away from the exterior 20 of the panel 12, wherein the hooks 58 are coupled to the rim of the vehicle. The gasket 16 is positioned on the panel 12 such that the gasket 16 is configured to reversibly seal the panel 12 to the rim of the vehicle wheel. The materials employed by the user in the treatment of the tire attached to the rim do not come into contact with the rim.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle wheel rim shielding device comprising:
a panel, said panel being circularly shaped and rigid, said panel having a circumference substantially equivalent to a perimeter of a rim of a vehicle wheel;
a gasket coupled to said circumference of said panel;
a handle coupled to said panel and positioned on an exterior of said panel;
a coupler coupled to said panel and extending from an interior of said panel, said coupler being configured to couple to the rim of the vehicle wheel to couple said panel to the rim; and
wherein said handle is positioned on said panel such that said handle is configured for grasping by a hand of the user to place said panel in abutment to the rim for treatment of the tire and to remove said panel from the rim upon completion of treatment of the tire, wherein said coupler is positioned on said panel such that said coupler is configured to couple said panel to the rim of the vehicle wheel, wherein said gasket is positioned on said panel such that said gasket is configured to reversibly seal said panel to the rim of the vehicle wheel, such that materials employed by a user in the treatment of a tire attached to the rim do not come into contact with the rim.

2. The device of claim 1, further including said panel being arcuate such that said panel is domed.

3. The device of claim 1, further including said gasket comprising rubber.

4. The device of claim 1, further including said handle being substantially centrally positioned on said panel.

5. The device of claim 4, further including said handle comprising a bar having opposing ends, said bar being arcuate, said opposing ends being coupled to said panel, wherein said bar is positioned on said panel such that said handle is configured for insertion of fingers of the hand of the user between said panel and said bar.

6. The device of claim 1, further including said coupler comprising:
a hole centrally positioned through said panel;
a first rod slidably positionable through said hole such that a first end of said first rod is positioned vincinal to said exterior of said panel and a second end of said first rod is positioned vincinal to said interior of said panel;
a fastener positioned on said first rod between said first end of said first rod and said exterior of said panel, said fastener being reversibly couplable to said first rod, wherein said fastener is positioned on said first rod such that said fastener is positioned to selectively couple to said first rod to selectively prevent longitudinal movement of said first rod into said hole;
a pair of second rods, each said second rod being coupled to and extending angularly from said second end of said first rod, said second rods being opposingly positioned;
a pair of hooks, said hooks being coupled singly to said second rods distal from said first rod; and
wherein said fastener is positioned on said first rod such that said fastener is positioned to selectively couple to said first rod to selectively prevent longitudinal movement of said first rod into said hole, wherein said first rod is positioned through said panel such that said first end of said first rod is configured for the user to motivate said first rod through said hole such that said first end is motivated toward said exterior of said panel and said second end of said first rod is motivated away from said interior of said panel, such that said hooks are configured to couple to the rim of the vehicle, and wherein said first rod is configured for the user to motivate said first rod through said hole such that said first end is motivated away from said exterior of said panel and said second end of said first rod is motivated toward said interior of said panel, such that said hooks are coupled to the rim of the vehicle.

7. The device of claim 6, further comprising:
said handle being substantially centrally positioned on said panel; and
said first rod being slidably positionable through a penetration positioned through said handle.

8. The device of claim 6, further including said first rod comprising a pair of shafts.

9. The device of claim 8, further including a pair of extensions coupled singly to and extending from said shafts distal from said panel, said extensions being arcuate, said extensions being opposing positioned defining a grip.

10. The device of claim 7, further including said fastener being positioned on said first rod between said handle and said first end of said first rod.

11. The device of claim 1, further including said fastener comprising a spring clamp, said spring clamp comprising a pair of coils and a release button, said release button being operationally coupled to said coils, wherein said release button is positioned in said spring clamp such that said release button is configured for reversible depression such that said coils are reversibly compressed, wherein said spring clamp is decoupled from said first rod such that said first rod is slidably positionable with said hole.

12. The device of claim 6, further comprising:
a cylinder coupled to and extending from said second end of said first rod; and
said second rods being coupled to said cylinder.

13. The device of claim 6, further including said hooks being C-shaped.

14. A vehicle wheel rim shielding device comprising:
a panel, said panel being circularly shaped and rigid, said panel having a circumference substantially equivalent to a perimeter of a rim of a vehicle wheel, said panel being arcuate such that said panel is domed;
a gasket coupled to said circumference of said panel, wherein said gasket is positioned on said panel such that said gasket is configured to reversibly seal said panel to the rim of the vehicle wheel, such that materials employed by a user in the treatment of a tire attached to the rim do not come into contact with the rim, said gasket comprising rubber;
a handle coupled to said panel and positioned on an exterior of said panel, wherein said handle is positioned on said panel such that said handle is configured for grasping by a hand of the user to place said panel in abutment to the rim for treatment of the tire and to remove said panel from the rim upon completion of treatment of the tire, said handle being substantially centrally positioned on said panel, said handle comprising a bar having opposing ends, said bar being arcuate, said opposing ends being coupled to said panel, wherein said bar is positioned on said panel such that said handle is configured for insertion of fingers of the hand of the user between said panel and said bar;
a coupler coupled to said panel and extending from an interior of said panel, said coupler being configured to couple to the rim of the vehicle wheel to couple said panel to the rim, wherein said coupler is positioned on said panel such that said coupler is configured to couple said panel to the rim of the vehicle wheel, said coupler comprising:
a hole centrally positioned through said panel,
a first rod slidably positionable through said hole such that a first end of said first rod is positioned vincinal to said exterior of said panel and a second end of said first rod is positioned vincinal to said interior of said panel, said first rod being slidably positionable through a penetration positioned through said handle, said first rod comprising a pair of shafts,
a pair of extensions coupled singly to and extending from said shafts distal from said panel, said extensions being arcuate, said extensions being opposing positioned defining a grip,
a fastener positioned on said first rod between said first end of said first rod and said exterior of said panel, said fastener being reversibly couplable to said first rod, wherein said fastener is positioned on said first rod such that said fastener is positioned to selectively couple to said first rod to selectively prevent longitudinal movement of said first rod into said hole, said fastener being positioned on said first rod between said handle and said first end of said first rod, said fastener comprising a spring clamp, said spring clamp comprising a pair of coils and a release button, said release button being operationally coupled to said coils, wherein said release button is positioned in said spring clamp such that said release button is configured for reversible depression such that said coils are reversibly compressed, wherein said spring clamp is decoupled from said first rod such that said first rod is slidably positionable with said hole,
a cylinder coupled to and extending from said second end of said first rod,
a pair of second rods, each said second rod being coupled to and extending angularly from said second end of said first rod, said second rods being opposingly positioned, said second rods being coupled to said cylinder,
a pair of hooks, said hooks being coupled singly to said second rods distal from said first rod, said hooks being C-shaped, and
wherein said fastener is positioned on said first rod such that said fastener is positioned to selectively couple to said first rod to selectively prevent longitudinal movement of said first rod into said hole, wherein said first rod is positioned through said panel such that said first end of said first rod is configured for the user to motivate said first rod through said hole such that said first end is motivated toward said exterior of said panel and said second end of said first rod is motivated away from said interior of said panel, such that said hooks are configured to couple to the rim of the vehicle, and wherein said first rod is configured for the user to motivate said first rod through said hole such that said first end is motivated away from said exterior of said panel and said second end of said first rod is motivated toward said interior of said panel, such that said hooks are coupled to the rim of the vehicle; and
wherein said handle is positioned on said panel such that said handle is configured for grasping by the hand of the user to place said panel in abutment to the rim for treatment of the tire and to remove said panel from the rim upon completion of treatment of the tire, wherein said release button is positioned in said spring clamp such that said release button is configured for reversible depression such that said coils are reversibly compressed, wherein said spring clamp is decoupled from said first rod such that said first rod is slidably positionable with said hole, wherein said first rod is configured for the user to motivate said first rod through said hole such that said first end is motivated toward said exterior of said panel, such that said hooks are configured to couple to the rim of the vehicle, and wherein said first rod is configured for the user to motivate said first rod through said hole such that said first end is motivated away from said exterior of said panel, such that said hooks are coupled to the rim of the vehicle, wherein said gasket is positioned on said panel such that said gasket is configured to reversibly seal said panel to the rim of the vehicle wheel, such that materials employed by the user in the treatment of the tire attached to the rim do not come into contact with the rim.
